(19) United States
(12) Patent Application Publication
(10) Pub. No.: US 2026/0029566 A1
(43) Pub. Date: Jan. 29, 2026

(54) LIGHTING STRUCTURE

(71) Applicant: Panasonic Automotive Systems Co., Ltd., Kanagawa (JP)

(72) Inventor: Kazuki ABE, Kanagawa Ken (JP)

(73) Assignee: Panasonic Automotive Systems Co., Ltd., Kanagawa (JP)

(21) Appl. No.: 19/263,137

(22) Filed: Jul. 8, 2025

(30) Foreign Application Priority Data
Jul. 29, 2024 (JP) 2024-122339

(51) Int. Cl. F21V 8/00

(52) U.S. Cl. CPC G02B 6/0045

(57) ABSTRACT

In a lighting structure, a columnar member extends in a first direction. A cylindrical member cylindrically extends in the first direction and covers a circumferential surface on a leading end side of the columnar member. A first light guiding member is provided between a light source and the leading end of the columnar member and is provided on a first side of the columnar member. A first member of a second light guiding member has a light transmissive property and a light diffusion property. The first member is provided inside the cylindrical member and provided on a second side of the columnar member. A second member of the second light guiding member has reflectivity and is provided inside the cylindrical member and outside the first member. The second member is interposed between the first light guiding member and the cylindrical member on the first side.

### CROSS-REFERENCE TO RELATED APPLICATIONS

This application is based upon and claims the benefit of priority from Japanese Patent Application No. 2024-122339, filed on Jul. 29, 2024, the entire contents of which are incorporated herein by reference.

### FIELD

The present disclosure relates generally to a lighting structure.

### BACKGROUND

A knob lighting structure has been known. In such a structure, a rotary switch is rotatably passed through an approximately cylindrical prism, and a manipulation knob attached to the leading end of the rotary switch is formed of a light transmissive material (See, for example, Patent literature JP 2020-009664 A).

With the configuration above, light emission can be performed by guiding light from a light source via the prism and the manipulation knob toward a translucent board provided on leading end of the manipulation knob, and thereby uniform lighting can be implemented.

In a lighting structure for lighting on the leading end side of a columnar member, a space available for arrangement is sometimes restricted near the columnar member by, for example, the circumference of the columnar member being covered by a cover panel or a cover glass.

In such a case, it is difficult to arrange an approximately cylindrical light guiding member around a columnar member, and it can be difficult to implement uniform lighting on the leading end side of the columnar member.

### SUMMARY

A lighting structure according to one aspect of the present disclosure includes a columnar member, at least one light source, a cylindrical member, a first light guiding member, and a second light guiding member. The columnar member extends in a first direction. The at least one light source is provided on a root side of the columnar member. The cylindrical member covers a circumferential surface on a leading end side of the columnar member. The cylindrical member cylindrically extends in the first direction. The first light guiding member has a light transmissive property. The first light guiding member is provided between the at least one light source and the leading end of the columnar member and provided on a first side of the columnar member. The second light guiding member includes a first member and a second member. The first member has a light transmissive property and a light diffusion property. The first member is provided on an inner side of the cylindrical member and provided on a second side of the columnar member. The second member having reflectivity. The second member is provided on the inner side of the cylindrical member and provided on an outer side of the first member. The second member is interposed between the first light guiding member and the cylindrical member on the first side.

### BRIEF DESCRIPTION OF THE DRAWINGS

FIG. 1 is a front view illustrating an external configuration of a lighting structure according to a first embodiment;

FIG. 2 is a cross-sectional diagram illustrating the lighting structure according to the first embodiment;

FIG. 3 is a front view illustrating a configuration in which a cylindrical member and a disk-shaped member are removed from the lighting structure according to the first embodiment;

FIG. 4 is a perspective view illustrating a positional relationship between columnar member, a cover glass, and a light guiding member (first light guiding member) in the first embodiment;

FIG. 5 is a front view illustrating a configuration in which a nearby cover is removed from the lighting structure according to the first embodiment;

FIG. 6 is a perspective view illustrating a configuration of the light guiding member (first light guiding member) in the first embodiment;

FIG. 7 is a perspective view illustrating a configuration of a light guiding member (second light guiding member) in the first embodiment;

FIG. 8 is a perspective view illustrating a partial configuration of the light guiding member (second light guiding member) in the first embodiment;

FIG. 9 is a perspective view illustrating another partial configuration of the light guiding member (second light guiding member) in the first embodiment;

FIG. 10 is a cross-sectional diagram illustrating a lighting structure according to a second embodiment;

FIG. 11 is a perspective view illustrating a partial configuration of a light guiding member (second light guiding member) in the second embodiment; and

FIG. 12 is a perspective view illustrating another partial configuration of the light guiding member (second light guiding member) in the second embodiment.

### DETAILED DESCRIPTION

Hereinafter, an embodiment of a lighting structure according to the present disclosure will be described with reference to the drawings.

### First Embodiment

A lighting structure according to the first embodiment is a structure that lights up the leading end side of a columnar member. The lighting structure is devised to implement uniform lighting on the leading end side of a columnar member in a case where a space available for arrangement is restricted near the columnar member.

A lighting structure 1 may be installed in a vehicle. In an interior of a vehicle, a columnar member such as a manipulation knob to be manipulated by an occupant of the vehicle is provided. In a case where, for example, the vehicle interior is dark such as a nighttime, the lighting structure 1 may light up the leading end side of the columnar member. With this configuration, in a case where the vehicle interior is dark, it is possible to easily recognize the position of the columnar member in the vehicle interior.

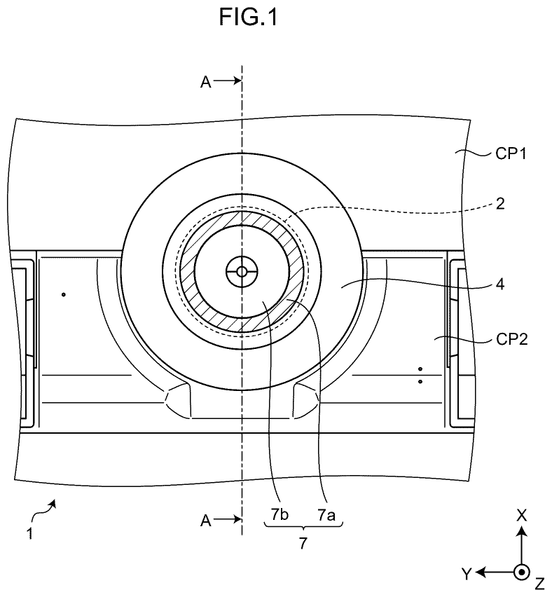

The lighting structure 1 may have a configuration as illustrated in FIG. 1. FIG. 1 is a front view illustrating an external configuration of the lighting structure 1.

The lighting structure 1 includes a columnar member 2, a cylindrical member 4, and a light guiding member (third light guiding member) 7. The circumferences of the columnar member 2, the cylindrical member 4, and the light guiding member 7 are covered by cover panels CP1 and CP2. Hereinafter, a direction that is vertical to the surface of the cover panel CP1 is defined as a Z direction, and two directions that are orthogonal to each other within a plane vertical to the Z direction are defined as an X direction and a Y direction.

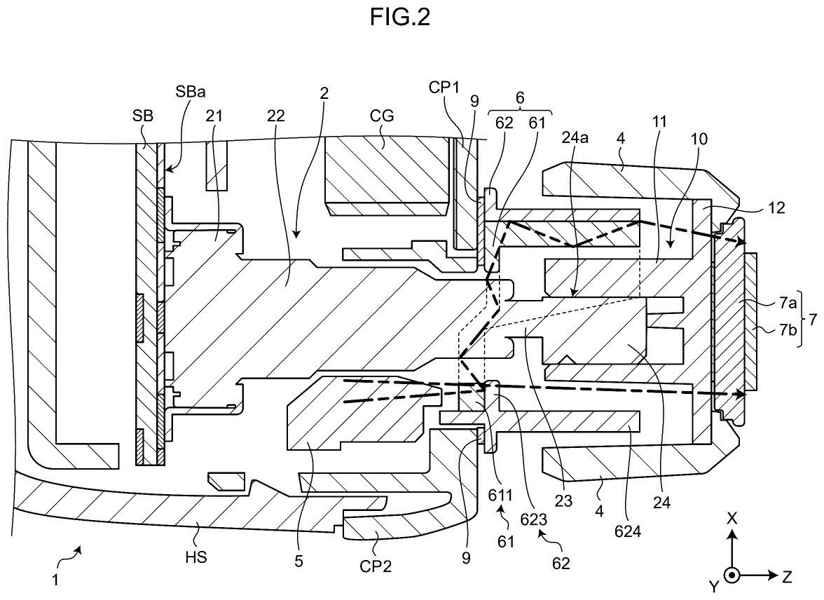

The columnar member 2 is provided on a substrate SB (refer to FIG. 2), and extends from the substrate SB in the Z direction. In a case where the lighting structure 1 is installed in a vehicle, the columnar member 2 may be a manipulation knob of a device (audio device, a navigation device, etc.) in a vehicle interior. The columnar member 2 may be a rotary switch such as an encoder that is rotatable around a Z-axis.

The cylindrical member 4 covers the leading end side (+Z side) of the columnar member 2 from the outer side in the X and Y directions. The cylindrical member 4 has reflectivity and a light-shielding property. The cylindrical member 4 can be formed of nontransparent plastic or the like. The cylindrical member 4 may be colored in black.

The light guiding member 7 covers one end (+Z side end) of the cylindrical member 4. The light guiding member 7 includes a light guiding part 7a and a light shielding part 7b. The light guiding part 7a has light transmissive and light diffusion properties. The light guiding part 7a can be formed of semitransparent plastic (for example, polycarbonate (PC) resin) or the like. The light guiding part 7a may have a semitransparent milky-white color.

The light shielding part 7b covers an inner region of the surface on the +Z side of the light guiding part 7a. The light shielding part 7b has reflectivity and a light-shielding property. A part of the light guiding part 7a that is not covered with the light shielding part 7b can have an annular shape in an XY-planar view. The light shielding part 7b can be formed of resin or the like. The light shielding part 7b may have a black color. The light shielding part 7b may be formed by blackening paint being applied to the inner region of the surface on the +Z side of the light guiding part 7a.

With this configuration, in the lighting structure 1, in accordance with light guided from the root side of the columnar member 2 toward the light guiding member 7, as illustrated in FIG. 1 by diagonal hatching, the leading end side of the columnar member 2 can be lighted up in a ring shape. In the ring-shaped lighting, uniform lighting is desired in a circumferential direction of a ring.

As illustrated in FIGS. 2 to 4, the lighting structure 1 further includes a light source 3, a light guiding member (first light guiding member) 5, a light guiding member (second light guiding member) 6, an elastic member 9, and an attaching member 10.

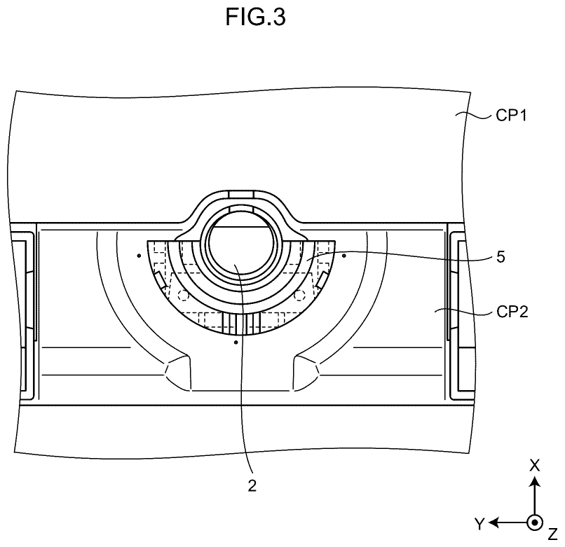

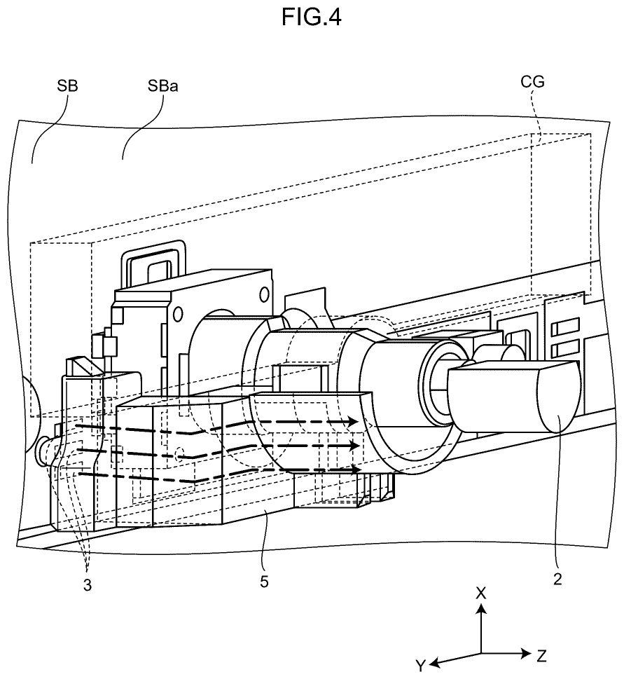

FIG. 2 is an XZ cross-sectional diagram illustrating the lighting structure 1, and illustrates an XZ cross-section taken along an A-A line in FIG. 1. FIG. 3 is an XY front view illustrating a configuration in which the cylindrical member 4 and a disk-shaped member 8 are removed from the lighting structure 1. FIG. 4 is a perspective view illustrating a positional relationship between a cover glass CG and a light guiding member 5 of the columnar member 2.

As illustrated in FIGS. 2 to 4, in the lighting structure 1, due to design constraints, the circumference of the columnar member 2 in the X and Y directions is covered in its middle part by the cover panels CP1 and CP2, and the cover glass CG. Thus, in the lighting structure 1, a space available for arrangement is restricted near the middle part of the columnar member 2 in the X and Y directions.

The columnar member 2 illustrated in FIG. 2 has an approximately columnar shape with an axis extending in the Z direction. The columnar member 2 includes a root part 21, a middle part 22, a small diameter part 23, and a leading end part 24 in order in the Z direction. The root part 21 is a part on the −Z side of the columnar member 2, is provided on a surface SBa of the substrate SB on the −Z side, and is connected to the middle part 22 on the +Z side. An X-width of the root part 21 is larger than that of the middle part 22, and a Y-width is larger than that of the middle part 22. The root part 21 may have an approximate cuboid shape. The middle part 22 is a part of the columnar member 2 that exists between the root part 21 and the small diameter part 23, is connected to the root part 21 on the −Z side, and is connected to the small diameter part 23 on the +Z side. The middle part 22 may be an approximately columnar shape. A diameter of the middle part 22 may become gradually smaller from the −Z side toward the +Z side. The small diameter part 23 is a part of the columnar member 2 that exists between the middle part 22 and the leading end part 24, and may have an approximately columnar shape. A diameter of the small diameter part 23 is smaller than that of the middle part 22. The leading end part 24 is a part on the +Z side of the columnar member 2, and is connected to the small diameter part 23 on the −Z side. A diameter of the small diameter part 23 is smaller than that of the leading end part 24. The leading end part 24 may have a shape that part of an approximate-column is cut along a flat surface 24a extending along an axis.

As illustrated in FIGS. 2 to 4, the cover panels CP1 and CP2 and the cover glass CG cover a part of the middle part 22 of the columnar member 2 on the +X side near a connection part with the small diameter part 23. With this configuration, a space available for arrangement near the middle part 22 of the columnar member 2 in the X and Y directions is restricted to the −X side. Thus, the light source 3 and the light guiding member 5 are provided in a region on the −X side near the columnar member 2 in the X and Y directions circumference.

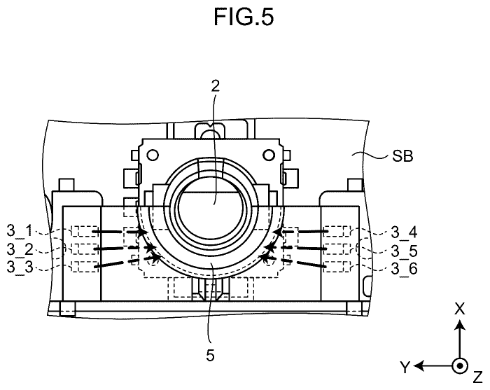

As illustrated in FIGS. 4 and 5, the light source 3 is provided in a region on the −X side at the periphery in the X and Y directions on the root side of the columnar member 2. FIG. 5 is a front view illustrating a configuration in which neighboring covers (the cover panels CP1 and CP2 and the cover glass CG) are removed from the lighting structure 1. As the light source 3, an optional light emission device such as a light emission diode (LED) may be used. A plurality of light sources 3_1 to 3_6 may be installed on the substrate SB. These light sources 3_1 to 3_6 are provided on the root side of the columnar member 2 and on both sides in the Y direction. In FIGS. 4 and 5, a configuration in which three light sources 3_1 to 3_3 are provided in the X direction on the +Y side of the columnar member 2, and the other three light sources 3_4 to 3_6 are provided in the X direction on the −Y side.

The light guiding member 5 is provided between the light sources 3 and the leading end of the columnar member 2, and on the −X side of the columnar member 2. The light guiding member 5 can be provided in such a manner as to cover each of the light sources 3_1 to 3_6 from the +Z side, and cover the root part 21 and the middle part 22 of the columnar member 2 on the −X side from the outer side in the X and Y directions. The light guiding member 5 is provided at a position closer to the −Z side than a light guiding member 6. The light guiding member 5 is provided on the inner side than the light guiding member 6 when viewed from the substrate SB, and is also called a light guide inner.

The light guiding member 5 has a light transmissive property. The light guiding member 5 may be transparent or semitransparent. The light guiding member 5 can be formed of glass, quartz, transparent plastic (for example, polymethylmethacrylate (PMMA) resin) or the like.

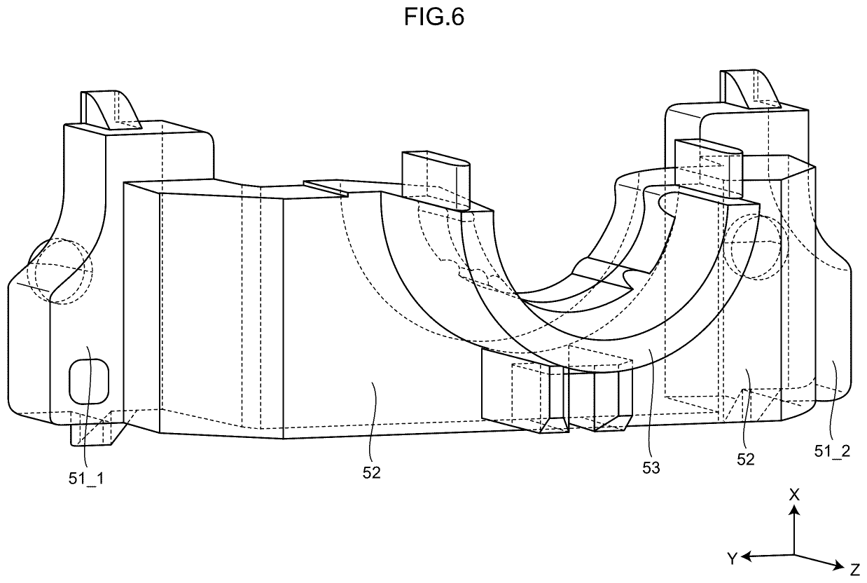

As illustrated in FIG. 6, the light guiding member 5 includes root parts 51_1 and 512, a bridge part 52, and a semicylinder part 53. FIG. 6 is a perspective view illustrating a configuration of the light guiding member 5.

The root part 511 is provided on the +Y side of the root part 21 of the columnar member 2, and extends in the X and Y directions like a plate. The root part 51_1 may have a shape in which +X side and +Y side parts of an approximate rectangle are chipped in an XY-planar view. The −Z side surface of the root part 51_1 faces the light sources 3_1 to 3_3 (refer to FIG. 5), and the +Z side surface is connected to a +Y side end part of the bridge part 52. With this configuration, as indicated by arrows of dashed-dotted lines in FIGS. 4 and 5, the root part 51_1 can guide light emitted from the light sources 3_1 to 3_3, to the +Y side end part of the bridge part 52.

The root part 51_2 illustrated in FIG. 6 is provided on the −Y side of the root part 21 of the columnar member 2, and extends in the X and Y directions like a plate. The root part 51_2 may have a shape in which +X side and −Y side parts of an approximate rectangle are chipped in an XY-planar view. The −Z side surface of the root part 51_2 faces the light sources 3_4 to 3_6 (refer to FIG. 5), and the +Z side surface is connected to a −Y side end part of the bridge part 52. With this configuration, as indicated by arrows of dashed-dotted lines in FIGS. 4 and 5, the root part 51_2 can guide light emitted from the light sources 3_4 to 3_6, to the −Y side end part of the bridge part 52.

The bridge part 52 illustrated in FIG. 6 extends like a bridge between the root part 51_1 and the root part 51_2, and the semicylinder part 53. The bridge part 52 may have an approximate U shape in which the −Z side is opened in a YZ planar view, or may be an approximately rectangular shape in an XY-planar view. The +Y side end part of the bridge part 52 is connected to the root part 51_1 on the −Z side, the −Y side end part is connected to the root part 512 on the −Z side, and a Y direction central part is connected to the semicylinder part 53 on the +Z side. With this configuration, as indicated by arrows of dashed-dotted lines in FIGS. 4 and 5, the bridge part 52 can guide light emitted from the root part 51_1, to the semicylinder part 53, and can guide light emitted from the root part 51_2, to the semicylinder part 53.

The semicylinder part 53 illustrated in FIG. 6 is provided in a region on the −X side at the periphery of the middle part 22 of the columnar member 2 in the X and Y directions. The semicylinder part 53 extends like a semicylinder in such a manner as to cover the middle part 22 of the columnar member 2 from the outer side in the X and Y directions. The −Z side end part of the semicylinder part 53 is connected to the bridge part 52, and the +Z side end part faces an −X side part of the light guiding member 6 in the Z direction as illustrated in FIG. 2. With this configuration, as indicated by arrows of dashed-dotted lines in FIG. 2, the semicylinder part 53 can guide light guided from the bridge part 52, to the −X side part of the light guiding member 6 or an internal part thereof.

The light guiding member 6 is provided between the light guiding member 5 and the light guiding member 7, and near the columnar member 2 in the X and Y directions circumference. The light guiding member 6 is provided on the outer side of the leading end part 24 of the columnar member 2 and the inner side of the cylindrical member 4. The light guiding member 5 can be provided in such a manner as to cover the small diameter part 23 and the leading end part 24 of the columnar member 2 from the outer side in the X and Y directions. The light guiding member 6 is provided at a position closer to the +Z side than the light guiding member 5. The light guiding member 6 is provided on the outer side than the light guiding member 5 when viewed from the substrate SB, and is also called a light guide outer.

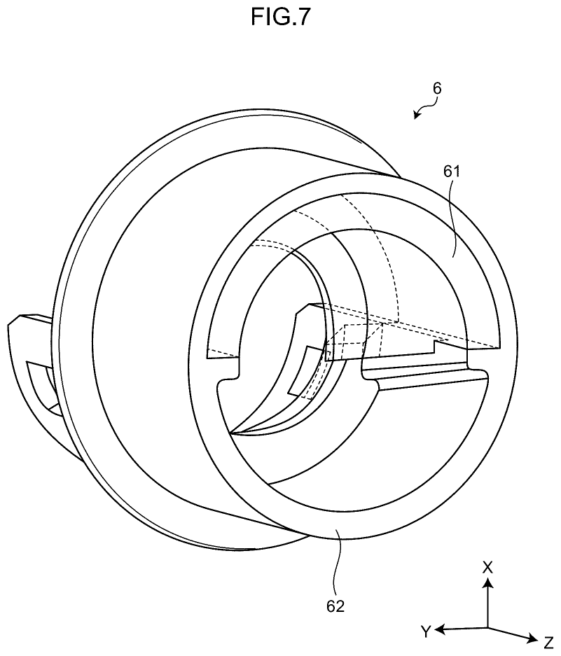

As illustrated in FIG. 7, the light guiding member 6 has an approximately cylindrical shape with an axis extending in the Z direction. FIG. 7 is a perspective view illustrating a configuration of the light guiding member 6. The light guiding member 6 includes an inner member (first member) 61 and an outer member (second member) 62. In the light guiding member 6, the inner member 61 may be provided on the inner side of the outer member 62 in the X and Y directions. The light guiding member 6 may be formed by the inner member 61 being attached to the inner side of the outer member 62 in the X and Y directions.

The inner member 61 has light transmissive and light diffusion properties. The inner member 61 is provided from the −X side toward the +X side of the columnar member 2, a −X side part faces the light guiding member 5 in the Z direction, and a +X side part extends in the Z direction toward the light guiding member 7. With this configuration, the inner member 61 can internally transmit light from the light guiding member 7 and guide the light to the light guiding member 7.

The inner member 61 is provided on the inner side of the cylindrical member 4 and near the columnar member 2 in the X and Y directions. The −X side part of the inner member 61 faces the semicylinder part 53 of the light guiding member 5 on the −Z side. The inner member 61 can be provided in such a manner as to cover the small diameter part 23 and the leading end part 24 of the columnar member 2 from the outer side in the X and Y directions.

A light transmission rate of the inner member 61 is larger than a light transmission rate of the outer member 62. The light transmission rate of the inner member 61 may be at an equal level to the light transmission rate of the light guiding member 5. A light diffusion rate of the inner member 61 is larger than a light diffusion rate of the light guiding member 5. The inner member 61 may have a semitransparent milky-white color. The inner member 61 can be formed of semitransparent plastic (for example, PC resin) or the like.

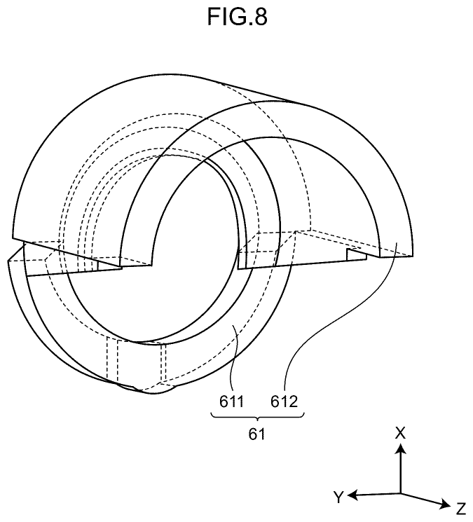

As illustrated in FIG. 8, the inner member 61 includes a hollow disk part 611 and a semicylinder part 612. FIG. 8 is a perspective view illustrating a partial configuration (the inner member 61) of the light guiding member 6.

As illustrated in FIGS. 2 and 8, the hollow disk part 611 is provided on the outer side in the X and Y directions in the vicinity of a connection part between the middle part 22 and the small diameter part 23 of the columnar member 2, and extends in the X and Y directions like a hollow disk. As illustrated in FIG. 2, in an XZ cross-sectional view, the hollow disk part 611 extends in the +X direction from the −X side part, sequentially bends toward the +Z side and the +X side near the center in the X direction, and extends in the +X direction up to +X side and −Z side end parts. A −X side part of the hollow disk part 611 faces a +Z side end part of the semicylinder part 53 of the light guiding member 5, and a +X side part is connected to a −Z side end part of the semicylinder part 612.

With this configuration, as indicated by arrows of dashed-two dotted lines in FIG. 2, the hollow disk part 611 can guide light that has been emitted from the +Z side end part of the semicylinder part 53 of the light guiding member 5 and entered the −X side part, to the −Z side end part of the semicylinder part 612 by transmitting the light while internally reflecting the light. Together with this, as indicated by arrows of dashed-dotted lines in FIG. 2, the hollow disk part 611 can guide light that has been emitted from the +Z side end part of the semicylinder part 53 of the light guiding member 5 and entered the inner side of the −X side part, to a −X side part of the light guiding member 7 by passing the light through in a hollow part.

As illustrated in FIGS. 2 and 8, the semicylinder part 612 is provided in a region on the +X side near the small diameter part 23 and the leading end part 24 of the columnar member 2 in the X and Y directions. The semicylinder part 612 extends like a semicylinder in such a manner as to cover the small diameter part 23 and the leading end part 24 of the columnar member 2 from the outer side in the X and Y directions. As illustrated in FIG. 2, in an XZ cross-sectional view, the semicylinder part 612 extends in the +Z direction from the −Z side end part up to the +Z side end part. The −Z side end part of the semicylinder part 612 is connected to a +X side part of the hollow disk part 611, and the +Z side end part faces a +X side part of the light guiding member 7 in the Z direction. With this configuration, as indicated by arrows of dashed-dotted lines in FIG. 2, the semicylinder part 612 can guide light guided from the hollow disk part 611, to the +X side part of the light guiding member 7.

The outer member 62 has reflectivity. As illustrated in FIGS. 2 and 7, the outer member 62 is interposed between the light guiding member 5 and the light guiding member 7. With this configuration, it is possible to block part of light traveling from the light guiding member 5 toward the light guiding member 7, cause the light to enter the inner member 61, and let another part of the light through to guide the light to the light guiding member 7. Further, the outer member 62 is provided on the outer side of the inner member 61 in the X and Y directions from the −X side toward the +X side of the columnar member 2. With this configuration, the outer member 62 can prevent light from leaking to the XY outer side of the inner member 61 when the inner member 61 guides light from the light guiding member 7 to the light guiding member 7 by internally transmitting the light.

The outer member 62 is provided on the inner side of the cylindrical member 4 and near the columnar member 2 in the X and Y directions. A −X side part of the outer member 62 is interposed between the semicylinder part 53 of the light guiding member 5 and the cylindrical member 4. The outer member 62 can be provided in such a manner as to cover the small diameter part 23 and the leading end part 24 of the columnar member 2 from the outer side in the X and Y directions.

An optical reflectivity of the outer member 62 is larger than an optical reflectivity of the inner member 61. The optical reflectivity of the outer member 62 is larger than an optical reflectivity of the light guiding member 5. The outer member 62 may have a while color. The outer member 62 can be formed of nontransparent plastic, (for example, acrylonitrile butadiene styrene (ABS) resin) or the like.

In addition, in this specification, “having reflectivity” refers to having a reflectance larger than a reflectance of a black body.

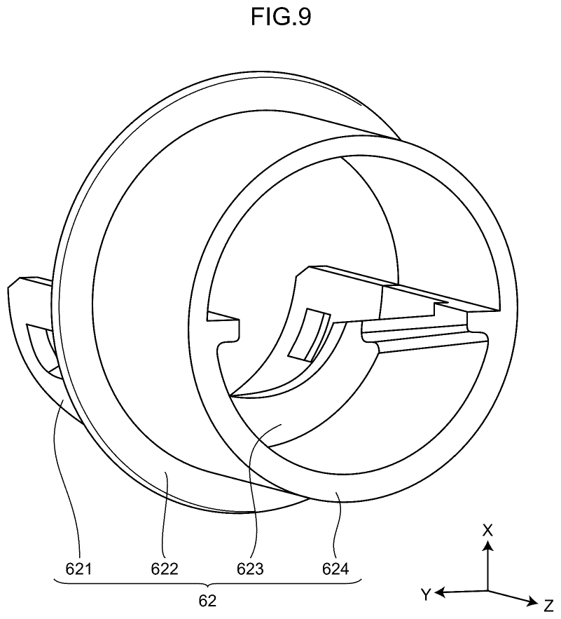

As illustrated in FIG. 9, the outer member 62 includes a semicylinder part 621, a hollow disk part 622, a hollow half disk part 623, and a cylinder part 624. FIG. 9 is a perspective view illustrating another partial configuration (the outer member 62) of the light guiding member 6.

As illustrated in FIGS. 2 and 9, the semicylinder part 621 is provided in a region on the −X side at the periphery in the X and Y directions in the vicinity of a connection part between the middle part 22 and the small diameter part 23 of the columnar member 2. The semicylinder part 621 extends like a semicylinder in such a manner as to cover the vicinity of the connection part between the middle part 22 and the small diameter part 23 of the columnar member 2 from the outer side in the X and Y directions. As illustrated in FIG. 2, in an XZ cross-sectional view, the semicylinder part 621 extends in the +Z direction from the −Z side end part up to the +Z side end part. A −Z side end part of the semicylinder part 621 faces the +Z side end part of the semicylinder part 53 of the light guiding member 5. A +Z side end part of the semicylinder part 621 is connected to a −X side part of the hollow disk part 622. An inner surface of the semicylinder part 621 in the X and Y directions may have contact with the hollow disk part 611 of the inner member 61. With this configuration, the semicylinder part 621 can position the inner member 61 when the inner member 61 is attached to the inner side of the outer member 62.

As illustrated in FIGS. 2 and 9, the hollow disk part 622 is provided on the outer side in the X and Y directions of the vicinity of the connection part between the middle part 22 and the small diameter part 23 of the columnar member 2, is provided on the outer side in the X and Y directions of the cylinder part 624, and extends in the X and Y directions in an annular shape. The −X side part of the hollow disk part 622 is fixed to the cover panel CP2 via the elastic member 9, and the +X side part is fixed to the cover panel CP1 via the elastic member 9. The elastic member 9 may have a light-shielding property. The hollow disk part 622 is connected to a −Z side end part of the cylinder part 624 on the +Z side.

With this configuration, the hollow disk part 622 can fix the outer member 62 to the cover panels CP1 and CP2. Together with this, the hollow disk part 622 can prevent light transmitted in the inner member 61, from leaking to the outer side in the X and Y directions.

As illustrated in FIGS. 2 and 9, the hollow half disk part 623 is provided in a region on the −X side at the periphery in the X and Y directions in the vicinity of a connection part between the middle part 22 and the small diameter part 23 of the columnar member 2. The hollow half disk part 623 extends like a hollow half disk in such a manner as to cover the vicinity of the connection part between the middle part 22 and the small diameter part 23 of the columnar member 2 from the outer side in the X and Y directions. As illustrated in FIG. 2, in an XZ cross-sectional view, the hollow half disk part 623 protrudes in the +Z direction from the −Z side end part of the cylinder part 624. A Z height of the hollow half disk part 623 from the −Z side end part of the cylinder part 624 is slightly lower than a Z height of the semicylinder part 53 (refer to FIG. 6) of the light guiding member 5 from the −Z side end part of the cylinder part 624. With this configuration, as indicated by arrows of dashed-dotted lines in FIG. 2, the hollow half disk part 623 can block part of light emitted from the semicylinder part 53 of the light guiding member 5, and let through another part of light emitted from the semicylinder part 53 of the light guiding member 5 on the +Z side.

As illustrated in FIGS. 2 and 9, the cylinder part 624 is provided near the small diameter part 23 and the leading end part 24 of the columnar member 2 in the X and Y directions. The cylinder part 624 extends like a cylinder in such a manner as to cover the small diameter part 23 and the leading end part 24 of the columnar member 2 from the outer side in the X and Y directions. As illustrated in FIG. 2, in an XZ cross-sectional view, the cylinder part 624 extends in the +Z direction from the −Z side end part up to the +Z side end part. The −Z side end part of the cylinder part 624 is connected to the +Z side end part of the semicylinder part 621, an inner end part in the X and Y directions of the hollow disk part 622, and an outer end part in the X and Y directions of the hollow half disk part 623, and the +Z side end part of the cylinder part 624 faces the light guiding member 7 in the Z direction. The cylinder part 624 covers the semicylinder part 612 of the inner member 61 on the +X side from the outer side in the X and Y directions.

With this configuration, as indicated by arrows of dashed-dotted lines in FIG. 2, by the +X side part, the cylinder part 624 can prevent light transmitted in the semicylinder part 612 of the inner member 61, from leaking to the outer side in the X and Y directions, and by the −X side part, prevent light passing through the inner side in the X and Y directions, from leaking to the outer side in the X and Y directions.

As described above, in the first embodiment, the lighting structure 1 partly blocks light traveling from the light guiding member 5 toward the light guiding member 7, by the outer member 62 of the light guiding member 6, guides the blocked light in the inner member 61 from the −X side toward the +X side, and guides the light to the +X side part of the light guiding member 7. The lighting structure 1 lets through light that has not been blocked, on the inner side of the outer member 62, and guides the light to the −X side part of the light guiding member 7. Accordingly, in a case where an arrangement location of the light guiding member 5 is restricted to a region on the −X side of the columnar member 2, it is possible to guide light from the light guiding member 5 to the −X side part and the +X side part of the light guiding member 7 by the light guiding member 6, and implement ring-shaped lighting uniform in the circumferential direction on the leading end side of the columnar member 2.

Further, in the first embodiment, in the lighting structure 1, the outer member 62 of the light guiding member 6 has reflectivity, and is interposed between the light guiding member 5 and the light guiding member 7. With this configuration, it is possible to block part of light traveling from the light guiding member 5 toward the light guiding member 7, cause the light to enter the inner member 61, and let another part of the light through to guide the light to the −X side part of the light guiding member 7. Further, the inner member 61 of the light guiding member 6 has light transmissive and light diffusion properties, is provided from the −X side toward the +X side of the columnar member 2, a −X side part faces the light guiding member 5 in the Z direction, and a +X side part extends in the Z direction toward the light guiding member 7. The outer member 62 is provided on the outer side of the inner member 61 in the X and Y directions from the −X side toward the +X side of the columnar member 2. With this configuration, while preventing light from leaking to the XY outer side of the inner member 61, the inner member 61 can guide light from the light guiding member 7 to the +X side part of the light guiding member 7 by internally transmitting the light.

In addition, the outer member 62 of the light guiding member 6 may have a semitransparent milky-white color, and nontransparent white color coating may be applied to the outer side of the outer member 62. The semicylinder part 621, the hollow disk part 622, the hollow half disk part 623, and the cylinder part 624 may each have a semitransparent milky-white color. Nontransparent white color coating may be applied to an outer surface in the X and Y directions of the semicylinder part 621, an exposed surface of the hollow disk part 622, an exposed surface of the hollow half disk part 623, and an outer surface in the X and Y directions of the cylinder part 624. Black color coating may be further applied to the outer side in the X and Y directions of the outer member 62. Black color coating may be further applied to an outer surface in the X and Y directions of the semicylinder part 621, an exposed surface of the hollow disk part 622, an exposed surface of the hollow half disk part 623, and an outer surface in the X and Y directions of the cylinder part 624. With this configuration as well, the outer member 62 can be caused to have reflectivity.

In the light guiding member 6, a Z direction length of the inner member 61 may be shorter than a Z direction length of the outer member 62. In this case, as indicated by arrows of dashed-two dotted lines in FIG. 2, light emitted from the inner member 61 can be guided to the light guiding member 7 while being reflected inside the outer member 62. With this configuration as well, it is possible to guide light emitted from the inner member 61, to the +X side part of the light guiding member 7.

### Second Embodiment

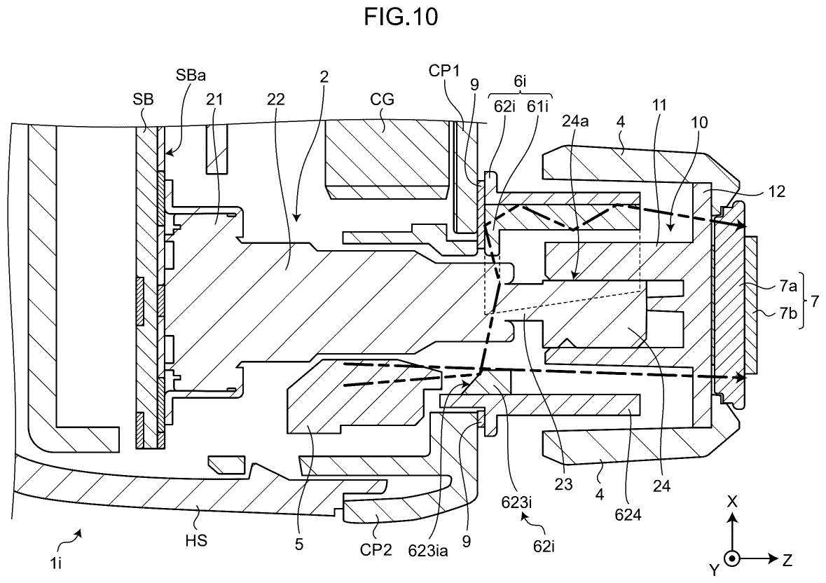

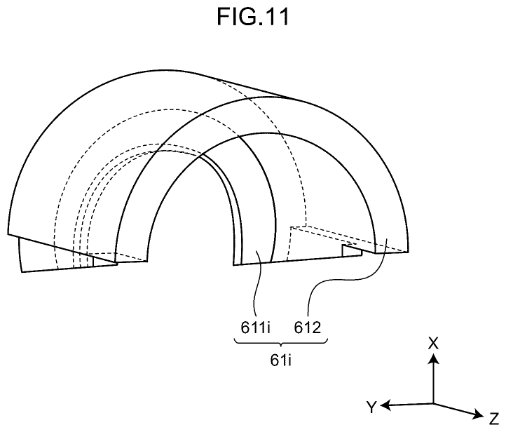

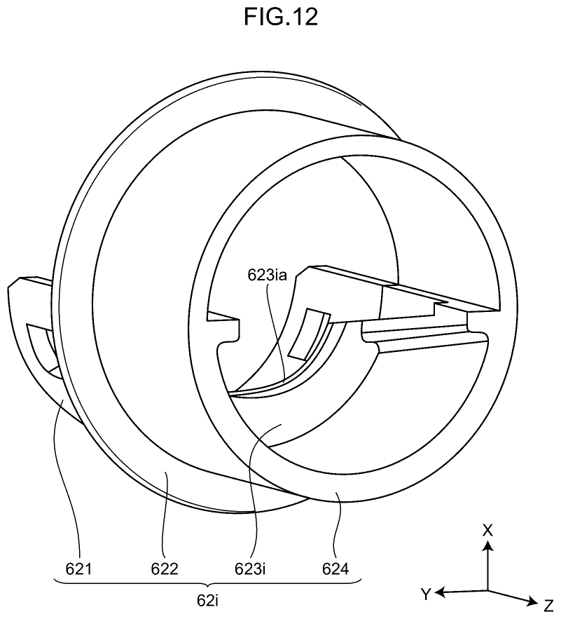

As illustrated in FIGS. 10 to 12, a lighting structure 1i may be configured to guide light blocked by partial light shielding by an outer member 62i, from the −X side toward the +X side by reflecting the light on a reflection surface 623iaa of the outer member 62i. FIG. 10 is a cross-sectional diagram illustrating the lighting structure 1i according to the second embodiment, and illustrates an XZ cross-section taken along an A-A line in FIG. 1. FIG. 11 is a perspective view illustrating a partial configuration (an inner member 61i) of a light guiding member 6i according to the second embodiment. FIG. 12 is a perspective view illustrating another partial configuration (the outer member 62i) of the light guiding member 6i according to the second embodiment.

The inner member 61i of the light guiding member 6i has light transmissive and light diffusion properties. As illustrated in FIGS. 10 and 11, the inner member 61i is provided at a position where reflected light on the reflection surface 623iaa of the outer member 62i can be received on the +X side of the columnar member 2. A +X side part of the inner member 61i extends in the Z direction toward the light guiding member 7. With this configuration, the inner member 61i can internally transmit reflected light from the outer member 62i and guide the light to the light guiding member 7.

In place of the hollow disk part 611 (refer to FIG. 8), the inner member 61i may include a hollow half disk part 611i illustrated in FIG. 11. The hollow half disk part 611i is provided in a region on the +X side at the periphery in the X and Y directions of the vicinity of the connection part between the middle part 22 and the small diameter part 23 of the columnar member 2, and extends in the X and Y directions like a hollow half disk. As illustrated in FIG. 10, in an XZ cross-sectional view, the hollow half disk part 611i extends in the +X direction from a −X side part up to a +X side part. The +X side part of the hollow half disk part 611i is connected to the −Z side end part of the semicylinder part 612. The hollow half disk part 611i is provided at a position where reflected light on the reflection surface 623iaa of the outer member 62i can be received on the +X side of the columnar member 2.

With this configuration, as indicated by arrows of dashed-two dotted lines in FIG. 10, the hollow half disk part 611i can guide light that has been reflected on the reflection surface 623iaa of the outer member 62i and entered the −X side part, to the −Z side end part of the semicylinder part 612 while internally reflecting the light.

The outer member 62i of the light guiding member 6i has reflectivity. As illustrated in FIGS. 10 and 12, the outer member 62i has a reflection surface 623ia that can reflect light from the light guiding member 5. The outer member 62i is interposed between the light guiding member 5 and the light guiding member 7. With this configuration, it is possible to cause part of light traveling from the light guiding member 5 toward the light guiding member 7, to enter the inner member 61i by reflecting the light on the reflection surface 623ia, and let another part of the light through to guide the light to the light guiding member 7. Further, the outer member 62i is provided on the outer side in the X and Y directions of the inner member 61i on the +X side of the columnar member 2. With this configuration, the outer member 62i can prevent light from leaking to the XY outer side of the inner member 61i when the inner member 61i guides light from the light guiding member 7 to the light guiding member 7 by internally transmitting the light.

In place of the hollow half disk part 623 (refer to FIG. 9), the outer member 62i includes a hollow half disk part 623i illustrated in FIG. 12.

As illustrated in FIGS. 10 and 12, the hollow half disk part 623i is provided in a region on the −X side at the periphery in the X and Y directions in the vicinity of a connection part between the middle part 22 and the small diameter part 23 of the columnar member 2. The hollow half disk part 623i extends like a hollow half disk in such a manner as to cover the vicinity of the connection part between the middle part 22 and the small diameter part 23 of the columnar member 2 from the outer side in the X and Y directions. As illustrated in FIG. 10, in an XZ cross-sectional view, the hollow half disk part 623i protrudes in the +Z direction from the −Z side end part of the cylinder part 624, and has the reflection surface 623ia that inclines in such a manner that a Z height from the −Z side end part of the cylinder part 624 becomes higher as getting away from the light guiding member 5, on the −Z side. With this configuration, as indicated by arrows of dashed-two dotted lines in FIG. 10, the hollow half disk part 623i can bend an optical axis from the light guiding member 5 side toward the inner member 61i side. That is, the hollow half disk part 623i can reflect light from the light guiding member 5, on the reflection surface 623ia, and cause the light to enter the hollow half disk part 611i of the inner member 61i.

A Z height of the hollow half disk part 623i from the −Z side end part of the cylinder part 624 is slightly lower than a Z height of the semicylinder part 53 (refer to FIG. 6) of the light guiding member 5 from the −Z side end part of the cylinder part 624. With this configuration, as indicated by arrows of dashed-dotted lines in FIG. 2, the hollow half disk part 623i can substantially block part of light emitted from the semicylinder part 53 of the light guiding member 5, and let through another part of light emitted from the semicylinder part 53 of the light guiding member 5 on the +Z side.

As described above, in the second embodiment, the lighting structure 1i causes light traveling from the light guiding member 5 toward the light guiding member 7, to be partly reflected on the reflection surface 623ia of the outer member 62i of the light guiding member 6i, causes the reflected light to enter the inner member 61i provided on the +X side, transmits the light inside the inner member 61i, and guides the light to the +X side part of the light guiding member 7. The lighting structure 1i lets through light that has not been reflected, on the inner side of the outer member 62i, and guides the light to the −X side part of the light guiding member 7. Accordingly, in a case where an arrangement location of the light guiding member 5 is restricted to a region on the −X side of the columnar member 2, it is possible to guide light from the light guiding member 5 to the −X side part and the +X side part of the light guiding member 7 by the light guiding member 6i, and implement ring-shaped lighting uniform in the circumferential direction on the leading end side of the columnar member 2.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lighting structure, comprising:
a columnar member extending in a first direction;
at least one light source provided on a root side of the columnar member;
a cylindrical member covering a circumferential surface on a leading end side of the columnar member, the cylindrical member cylindrically extending in the first direction;
a first light guiding member having a light transmissive property, the first light guiding member being provided between the at least one light source and the leading end of the columnar member and provided on a first side of the columnar member; and
a second light guiding member including a first member and a second member, the first member having a light transmissive property and a light diffusion property, the first member being provided on an inner side of the cylindrical member and provided on a second side of the columnar member, the second member having reflectivity, the second member being provided on the inner side of the cylindrical member and provided on an outer side of the first member, the second member being interposed between the first light guiding member and the cylindrical member on the first side.

2. The lighting structure according to claim 1, wherein
the first member has a milky-white color, and
the second member has a white color.

3. The lighting structure according to claim 1, wherein
the first member has a milky-white color, and
the second member has a milky-white color, and an outer side of the second member has coating with a white color.

4. The lighting structure according to claim 1, wherein
the first member is provided to extend from the first side toward the second side of the columnar member, and
a part of the first member on the first side faces the first light guiding member in the first direction.

5. The lighting structure according to claim 1, wherein
the second member includes a reflection surface configured to reflect light from the first light guiding member, and
the first member is provided at a position where reflected light from the reflection surface of the second member is received on the second side of the columnar member.

6. The lighting structure according to claim 4, wherein
the first member includes
a first part extending in an annular shape around the columnar member, and
a second part extending from the first part toward the leading end side of the columnar member on the second side of the columnar member, and
the second member includes
a third part provided between the first part and the cylindrical member, and
a fourth part cylindrically extending in the first direction from the third part toward the leading end side of the columnar member, the fourth part covering the second part from an outer side.

7. The lighting structure according to claim 5, wherein
the first member includes
a second part extending along the columnar member toward the leading end side of the columnar member on the second side of the columnar member, and
the second member includes
a third part provided between the first light guiding member and the cylindrical member, the third part bending an optical axis from the first light guiding member side toward the second part side, and
a fourth part cylindrically extending from the third part toward the leading end side of the columnar member along the columnar member, the fourth part covering the second part from an outer side.

8. The lighting structure according to claim 6, further comprising an elastic member provided between the second part and a panel on which the lighting structure is installed.

9. The lighting structure according to claim 7, further comprising an elastic member provided between the second part and a panel on which the lighting structure is installed.

10. The lighting structure according to claim 1, wherein a length in the first direction of the first member is shorter than a length in the first direction of the second member.

11. The lighting structure according to claim 1, further comprising a third light guiding member including a light guiding part and a light shielding part, the light guiding part having a light transmissive property and a light diffusion property, the light guiding part covering one end of the cylindrical member, the light shielding part having reflectivity and covering an inner region of the light guiding part.

12. The lighting structure according to claim 1, wherein
the at least one light source is constituted by a plurality of light sources, and
the plurality of light sources is provided on a root side of the columnar member and on the first side of the columnar member.
